(19) United States
(12) Patent Application Publication
(10) Pub. No.: US 2004/0216591 A1
(43) Pub. Date: Nov. 4, 2004

(54) Expression device for a cartridge comprising two chambers arranged comcentrically to each other

(76) Inventors: Amir Assadi, Emmendingen (DE); Juergen Gruen, Boetzingen (DE); Clements Schmidt, Denzingen (DE)

Correspondence Address: Striker Striker & Stenby, 103 East Neck Road, Huntington, NY, 11743, US

(21) Appl. No.: 10/479,680

(22) PCT Filed: Apr. 13, 2002
(86) PCT No.: PCT/EP02/04139

(30) Foreign Application Priority Data
Jun. 13, 2001 (DE) 101 28 611.2

(51) Int. Cl. B05C 17/01

(52) U.S. Cl. 89/1.14

(57) ABSTRACT

The invention relates to a discharge device for a cartridge (1) having two chambers (2, 3) that are arranged concentrically to one another and are closed by pistons (9, 10), the discharge device having a discharge ram (11) having a thread (12), which is axially displaceable by being screwed into an end piece which is arranged at the rear end of the cartridge (1) and has an internal thread (14). In order to allow simple manufacture of the discharge device and to facilitate its handling, the discharge ram (11) has an inner plunger (16) which exerts pressure on the piston (9) of the inner chamber (2) and, arranged concentrically with the inner plunger (16), an outer plunger (17) which exerts pressure on the ring-shaped piston (10) of the outer chamber (3), the outer surface of the outer plunger (17) being provided with the thread (12) which extends over its entire length. Furthermore, the end piece having the internal thread (14) is in the form of a threaded ring (13). As a result of this configuration of the discharge ram (11), it can be produced in the form of a one-piece component from plastics in an injection-moulding process.

The invention relates to a discharge device for a cartridge having two chambers that are arranged concentrically to one another and are closed by pistons, in accordance with the preamble of claim 1.

For discharging a cartridge that has only one tubular chamber it is known to attach a cap firmly to the rear end of the cartridge opposite the mouth, which cap has a central threaded bore. A threaded spindle provided with a wing-like handgrip can be screwed into the threaded bore, the end face of the threaded spindle striking the piston that closes the chamber and displacing the piston in the cartridge in the direction towards the mouth.

For emptying cartridges having two chambers that are arranged concentrically to one another and are closed by pistons, discharge guns are known which have for each piston a discharge ram formed by presser plates and presser rods. Such discharge guns are relatively expensive and are therefore generally used only by workpeople who regularly deal with such cartridges. It is therefore customary to sell the cartridges as single items without discharge pistols.

DE 298 23 237 U1 discloses a discharge device for a cartridge having two concentrically arranged chambers in which the discharge ram exerting pressure on the piston of the inner chamber is in the form of a threaded spindle. By screwing the threaded spindle into a threaded bore of a cap that is axially locked in position on the rear side of the cartridge, the piston is displaced in the direction towards the mouth of the cartridge. By means of a presser plate connected to the threaded spindle, on which presser plate there are arranged a plurality of presser rods guided in bores in the cap mounted on the rear side of the cartridge, during the advance movement of the threaded spindle the ring-shaped piston of the outer chamber is displaced axially parallel to the inner piston. In order to exert a uniform pressure on the ring-shaped piston, at least three presser rods are necessary, the end faces of which are connected to one another by means of a ring-shaped counter-bearing located opposite the presser plate. The connection of the end faces of the presser rods to the counter-bearing is possible only after the cap has been pushed on over the presser rods and the inner discharge ram. The cap together with the discharge device thus forms a unit which first requires interlocking of the cap and cartridge to be carried out by the user.

The known discharge device consists of a plurality of components that have to be matched to one another, which on the one hand increases production costs and on the other hand can result in operational problems. In view of this situation the problem underlying the invention is to provide a discharge device which is cost-effective to produce and offers a high degree of operational reliability.

The solution to this problem is achieved by the features given in claim 1. In the discharge device according to the invention, the discharge ram is a one-piece component, preferably produced from plastics in an injection-moulding process, having an inner plunger that exerts pressure on the piston of the inner chamber of the cartridge and having, arranged concentrically with the inner plunger, a tubular outer plunger which exerts pressure on the ring-shaped piston of the outer chamber. The advance movement of the discharge ram is achieved by a thread on the outer surface of the outer plunger, which thread extends over the entire length of the outer plunger. The external thread engages the internal thread of a threaded ring which is firmly inserted as end piece on the rear end of the outer chamber of the cartridge, for example by interlocking engagement or adhesive bonding. The arrangement of the thread on the outer surface of the outer plunger results in a thread having the greatest possible diameter, which provides a high discharge pressure combined with a small screwing-in moment and tilt-free guidance of the discharge ram. The end faces of the inner and outer plungers each form an annular bearing surface, which bearing surfaces displace the pistons in the direction towards the mouth of the cartridge when the discharge ram is screwed in.

The discharge device according to the invention consists of the one-piece discharge ram and the threaded ring, which can likewise be produced from plastics in an injection-moulding process, which ring is preferably inserted into the outer chamber of the cartridge in the factory. The discharge device is cost-effective to produce because it consists of only two components and does not require assembly.

In order to save materials in the production of the discharge ram it is advantageous for the thread to be formed merely by a plurality of thread strips running in the longitudinal direction.

To improve guidance it is advantageous on the one hand for the thread to be in trapezoidal form and on the other hand for the threaded ring to have at least two threads.

For the purpose of being screwed in manually, the discharge ram has a wing-like rotatable grip at its rear end. For screwing in mechanically, in addition to the rotatable grip a hexagonal socket can be provided for receiving a suitable tool.

An exemplary embodiment of the invention is shown in the drawing.

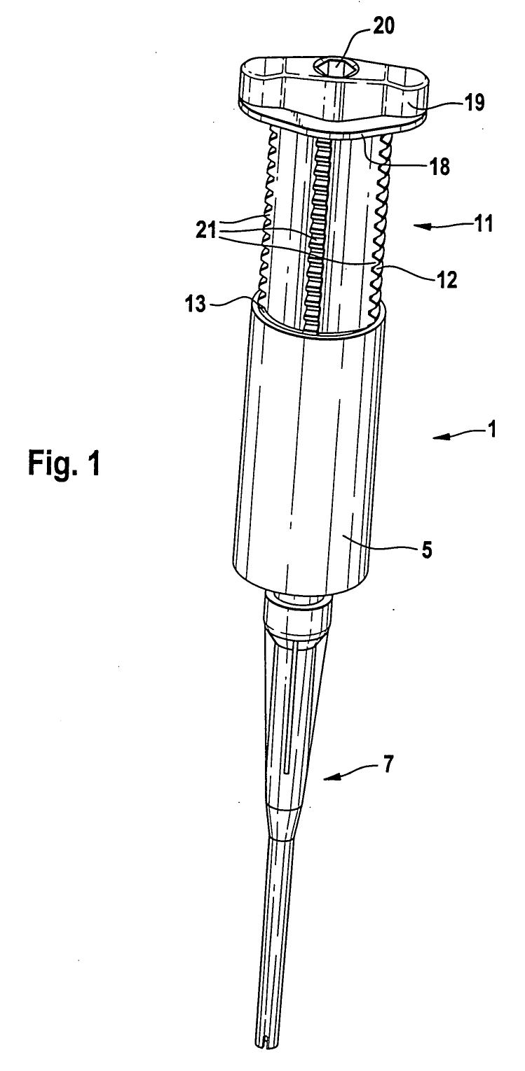

FIG. 1 is a perspective view of the cartridge with the discharge device;

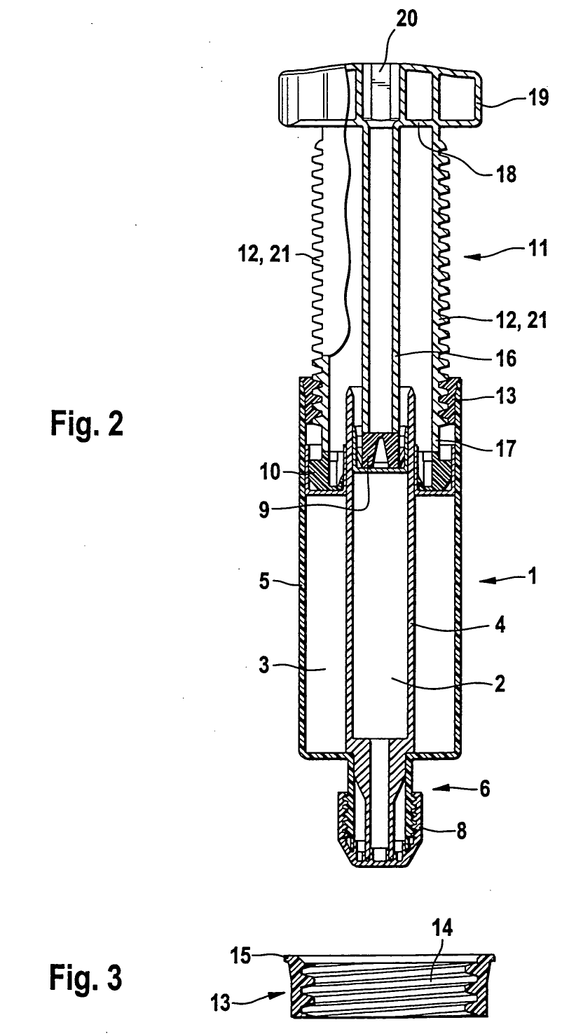

FIG. 2 shows the cartridge with the discharge device in longitudinal section; and

FIG. 3 shows the threaded ring in section.

The cartridge 1 shown in FIGS. 1 and 2 is a two-component cartridge having two concentrically arranged chambers 2, 3, each for one of the two components. The inner chamber 2 is formed by an inner tube 4 and the outer, ring-shaped chamber 3 is formed by an outer tube 5. The outlet openings of the two chambers terminate in a cartridge mouth 6, on which there is mounted a static mixer 7 in FIG. 1 and a closure cap 8 in FIG. 2. The two chambers 2, 3 are closed by pistons 9, 10, the piston 10 for the outer chamber 3 being ring-shaped. The volumes of the chambers 2, 3 correspond to the mixing ratio of the two components contained in the chambers. In order to obtain uniform intermixing of the components it is therefore necessary to move the two pistons uniformly in the direction towards the mouth 6 of the cartridge.

This is achieved using the discharge ram 11, which engages by its thread 12 in a threaded ring 13 which is inserted at the rear end of the outer tube 5 of the cartridge 1. For securing the threaded ring 13, in the exemplary embodiment shown it is adhesively bonded in the outer tube 5. The threaded ring 13 shown in detail in FIG. 3 has an internal thread 14 corresponding to the thread 12 of the discharge ram 11. In order to avoid tilting when the discharge ram 11 is being screwed into the threaded ring 13, the threaded ring 13 has at least two complete threads, preferably in trapezoidal form. In order to facilitate its insertion, the threaded ring 13 is provided with a collar 15 which is seated on the rear end face of the outer tube 5. The discharge ram 11 has an inner plunger 16, which is seated on the piston 9 of the inner chamber 2, and an outer plunger 17, which is seated on the ring-shaped piston 10 of the outer chamber 3. The two plungers are tubular and arranged concentrically to one another. At the rear end of the discharge ram 11, formed by a base plate 18, there is arranged a wing-like rotatable grip 19 which enables the discharge ram 11 to be screwed in manually. For mechanical screwing-in, the rotatable grip 19 is provided in the centre with a hexagonal socket 20 which enables a suitable tool to be received for mechanical screwing-in.

The discharge ram 11 is produced as a one-piece component from plastics in an injection-moulding process. In order to save materials, the thread 12 is formed by a plurality of thread strips 21 running in the longitudinal direction. In order to prevent tilting during screwing-in, at least three thread strips 21 are necessary. In the exemplary embodiment four thread strips are provided.

Depending upon the amount of the components introduced into the chambers 2, 3, the pistons 9, 10 are either both at the same level or, as shown in the exemplary embodiment, are spaced slightly apart. In the latter case the end faces of the inner and outer plungers 16, 17 are also spaced apart by the same amount in order that the two pistons are displaced axially in parallel with one another.

1. Discharge device for a cartridge (1) having two chambers (2, 3) that are arranged concentrically to one another and are closed by pistons (9, 10), the discharge device consisting of a discharge ram (11) having a thread (12), which is axially displaceable in the direction towards the mouth (6) of the cartridge by being screwed into an end piece which is arranged at the rear end of the cartridge (1) and has an internal thread (14), characterised in that the discharge ram (11) has an inner plunger (16) which exerts pressure on the piston (9) of the inner chamber (2) and, arranged concentrically with the inner plunger, a tubular outer plunger (17) which exerts pressure on the ring-shaped piston (10) of the outer chamber (3), the thread (12) being arranged on the outer surface of the outer plunger (17) and extending over its entire length; and the end piece is in the form of a threaded ring (13).

2. Discharge device according to claim 1, characterised in that the thread (12) is formed by a plurality of thread strips (21) running in the longitudinal direction.

3. Discharge device according to claim 1, characterised in that the thread (12) is in trapezoidal form.

4. Discharge device according to claim 1, characterised in that the threaded ring (13) has at least two threads and is fixed in the outer chamber (5) of the cartridge (13) by means of interlocking engagement, adhesive bonding or the like.

5. Discharge device according to claim 1, characterised in that the discharge ram (11) has a wing-like rotatable grip (19) at its rear end.

6. Discharge device according to claim 1 or 5, characterised in that the discharge ram (11) has a hexagonal socket (20) for receiving a tool.

7. Discharge device according to claim 1, characterised in that the discharge ram (11) is produced in one piece from plastics in an injection-moulding process.
